(19) United States
(12) Patent Application Publication
(10) Pub. No.: US 2024/0126890 A1
(43) Pub. Date: Apr. 18, 2024

(54) APPARATUS FOR VERIFYING SOFTWARE INTEGRITY OF VEHICLE CONTROLLER AND METHOD THEREOF

(71) Applicants: HYUNDAI MOTOR COMPANY, Seoul (KR); Kia Corporation, Seoul (KR)

(72) Inventors: Hye Ryun LEE, Suwon-si (KR); Kyung Tae NOH, Hwaseong-si (KR); Min Ho HEO, Hwaseong-si (KR); Sug Woo SHIN, Suwon-si (KR); Duk Won HONG, Hwaseong-si (KR); Dong Jun AHN, Anyang-si (KR)

(73) Assignees: HYUNDAI MOTOR COMPANY, Seoul (KR); Kia Corporation, Seoul (KR)

(21) Appl. No.: 18/136,546

(22) Filed: Apr. 19, 2023

(30) Foreign Application Priority Data
Oct. 13, 2022 (KR) 10-2022-0131746

(51) Int. Cl. G06F 21/57; G06F 8/65

(52) U.S. Cl. CPC G06F 21/577; G06F 8/65; G06F 21/572; G06F 2221/033

(57) ABSTRACT

An apparatus of verifying a software integrity of a vehicle controller and a method thereof includes a communication device that provides a communication interface with a software management system, and a controller which is configured to obtain first verification data of the vehicle controller from the software management system, obtains second verification data from the vehicle controller, and verifies an integrity of software loaded in the vehicle controller based on the obtained first verification data and the obtained second verification data.

### CROSS-REFERENCE TO RELATED APPLICATION

The present application claims priority to Korean Patent Application No. 10-2022-0131746, filed on Oct. 13, 2022, the entire contents of which is incorporated herein for all purposes by this reference.

### BACKGROUND OF THE PRESENT DISCLOSURE

### Field of the Present Disclosure

The present disclosure relates to a technique for verifying integrity of software loaded in a vehicle controller.

### Description of Related Art

As functions related to acceleration, braking, and safety of vehicles are electronicized, various controllers for controlling them are provided in vehicles, and accordingly, the type and complexity of software loaded in each controller is increasing.

The software update method includes an update method through an Over The Air (OTA), an update method using a Universal Serial Bus (USB), and an update method using a dedicated equipment. Accordingly, the software loaded in a vehicle controller may be updated in various ways, illegal hacking by a Distributed Denial of Service attack (DDoS) and a software modification by illegal tuning in an aftermarket may occur frequently.

In the present way, when the software modification due to illegal hacking by the DDoS or the software modification due to illegal tuning in the aftermarket occur, a fatal problem may occur in the vehicle due to the present modifications, and thus driver safety cannot be guaranteed.

Accordingly, a United Nations Economic Commission for Europe (UNECE) has designated the integrity verification of controller software as a legal item. In other words, the UNECE has designated R156.00 regulation to check the relevance with a Vehicle Type Approval (VTA) and to regulate so that safe updates may be made when the software loaded in the vehicle controller is modified. Therefore, to sell vehicles in Europe, as it may be certified whether or not it satisfies the European regulation R156.00 (Software Update Management System) before mass production, it is necessary to establish a software update management system that satisfies the regulation R156.00.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and a method for verifying a software integrity of a vehicle controller configured for detecting software modifications due to illegal hacking or software modifications caused by illegal tuning in a aftermarket by obtaining a first Integrity Validation Data (IVD) of the vehicle controller from a Software Update Management System (SUMS), obtaining a second IVD from the vehicle controller, and verifying integrity of software loaded in the vehicle controller based on the first IVD and the second IVD, in an environment in which the vehicle controller performs a firmware update in conjunction with the SUMS.

The technical problems to be solved by the present disclosure are not limited to the aforementioned problems, and any other technical problems not mentioned herein will be clearly understood from the following description by those skilled in the art to which the present disclosure pertains. Furthermore, it will be easily understood that the objects and advantages of the present disclosure are realized by means and combinations described in the appended claims.

According to an aspect of the present disclosure, an apparatus of verifying a software integrity of a vehicle controller includes a communication device that provides a communication interface with a software management system, and a controller which is configured to obtain first verification data of the vehicle controller from the software management system, obtains second verification data from the vehicle controller, and verifies an integrity of software loaded in the vehicle controller based on the obtained first verification data and the obtained second verification data.

According to an exemplary embodiment of the present disclosure, the controller may be configured to determine that the software loaded in the vehicle controller has the integrity, when the controller concludes that the obtained first verification data and the obtained second verification data are identical to each other.

According to an exemplary embodiment of the present disclosure, the controller may obtain a plurality of verification data corresponding to the vehicle controller from the software management system, may compare whether the plurality of verification data obtained from the software management system and a plurality of verification data obtained from the vehicle controller are identical to each other when the plurality of verification data is obtained from the vehicle controller, and may be configured to determine that the software loaded in the vehicle controller has the integrity when the controller concludes that the verification data are identical to each other.

According to an exemplary embodiment of the present disclosure, the software management system may manage a software package and version information and verification data of the software package for each program forming the software loaded in the vehicle controller.

According to an exemplary embodiment of the present disclosure, vehicle controller may perform a firmware update based on the software package received from the software management system.

According to an exemplary embodiment of the present disclosure, the vehicle controller may be configured to determine verification data based on the software package when a vehicle is started on (IGN ON), and may transmit the verification data upon request from the controller.

According to an exemplary embodiment of the present disclosure, the vehicle controller may be configured to determine verification data based on the software package upon request from the controller, and transmits the determined verification data to the controller.

According to an exemplary embodiment of the present disclosure, the vehicle controller may be configured to transmit the determined verification data to the controller when an additional request is received from the controller, without determining additionally the verification data when a vehicle is started on (IGN ON).

According to an exemplary embodiment of the present disclosure, the vehicle controller may be configured to determine the second verification data based on a secure flash library or a crypto library.

According to an exemplary embodiment of the present disclosure, the second verification data may be any one of a Secure Hash Algorithm (SHA)-1 value, a SHA-2 value, a Cyclic Redundancy Check (CRC) 16 value, and a CRC 32 value.

According to an aspect of the present disclosure, a method of verifying a software integrity of a vehicle controller includes obtaining, by a controller, first verification data of the vehicle controller from the software management system; obtaining, by the controller, second verification data from the vehicle controller; and verifying, by the controller, an integrity of software loaded in the vehicle controller based on the obtained first verification data and the obtained second verification data.

According to an exemplary embodiment of the present disclosure, the verifying of the integrity of software loaded in the vehicle controller may determine that the software loaded in the vehicle controller has the integrity, when the controller concludes that the obtained first verification data and the obtained second verification data are identical to each other.

According to an exemplary embodiment of the present disclosure, the verifying of the integrity of software loaded in the vehicle controller may further include obtaining a plurality of verification data corresponding to the vehicle controller from the software management system, and comparing whether the plurality of verification data obtained from the software management system and a plurality of verification data obtained from the vehicle controller are identical to each other when the plurality of verification data is obtained from the vehicle controller; and determining that the software loaded in the vehicle controller has the integrity when the controller concludes that the verification data are identical to each other.

According to an exemplary embodiment of the present disclosure, the method may further include managing, by the software management system, a software package and version information and verification data of the software package for each program forming the software loaded in the vehicle controller; and performing, by the vehicle controller, a firmware update based on the software package received from the software management system.

According to an exemplary embodiment of the present disclosure, the method may further include determining, by the vehicle controller, verification data based on the software package when a vehicle is started on (IGN ON); and transmitting, by the vehicle controller, the verification data upon request from the controller.

According to an exemplary embodiment of the present disclosure, the method may further include determining, by the vehicle controller, verification data based on the software package upon request from the controller; and transmitting, by the vehicle controller, the determined verification data to the controller.

According to an exemplary embodiment of the present disclosure, the method may further include transmitting the determined verification data to the controller when an additional request is received from the controller, without determining additionally the verification data when a vehicle is started on (IGN ON).

According to an exemplary embodiment of the present disclosure, the obtaining of the second verification data from the vehicle controller may include determining, by the vehicle controller, the second verification data based on a secure flash library or a crypto library.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram of a software integrity verification system of a vehicle controller, according to an exemplary embodiment of the present disclosure;

FIG. 2 is a diagram illustrating functions of a security system, an SPS, and a SUMS provided in a software integrity verification system of a vehicle controller, according to an exemplary embodiment of the present disclosure;

FIG. 3 is a diagram illustrating a detailed information registration screen for a software package of a SUMS provided in a software integrity verification system of a vehicle controller, according to an exemplary embodiment of the present disclosure;

FIG. 4 is a first example diagram illustrating a time when a vehicle controller provided in a software integrity verification system of a vehicle controller according to an exemplary embodiment of the present disclosure determines an IVD;

FIG. 5 is a second example diagram illustrating a time when a vehicle controller provided in a software integrity verification system of a vehicle controller according to an exemplary embodiment of the present disclosure determines an IVD;

FIG. 6 is a schematic diagram of a software integrity verification apparatus of a vehicle controller, according to an exemplary embodiment of the present disclosure;

FIG. 7 is a flowchart of a software integrity verification method of a vehicle controller, according to an exemplary embodiment of the present disclosure; and

FIG. 8 is a block diagram illustrating a computing system for executing a software integrity verification method of a vehicle controller, according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of the related known configuration or function will be omitted when it is determined that it interferes with the understanding of the exemplary embodiment of the present disclosure.

In describing the components of the exemplary embodiment of the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as including a meaning which is consistent with their meaning in the context of the relevant art and will not be interpreted in an idealized or overly formal sense unless expressly so defined herein.

Regulation R156.00 related to software updates prescribed by the United Nations Economic Commission for Europe (UNECE) stipulates multiple requirements for the software update management system to establish processes and manage deliverables throughout in-vehicle software updates, and requires vehicle manufacturers to obtain certification of compliance with R156.00. When software modifications are required for mass-produced vehicles, the Regulation R156.00 requires each vehicle manufacturer to record and manage an RXSWIN (Regulation X Software Identification Number) to check the relevance with Vehicle Type Approval (VTA) and safely update.

The RXSWIN is a unique identification number for identifying the software version of an electronic control unit (ECU) associated with each type of type approval of the European Applicable Regulations (RX). For example, when a vehicle obtains type approval for “R-48 Light Installation” regulation, an identifier indicating a combination of software versions of control units (e.g., an IBU, an ICU, or the like) related to the requirements of the regulation may be recorded as the RWSWIN.

The R156.00 regulation stipulates that RXSWIN should satisfy the following 6 requirements. The RXSWIN should 1) be managed in conjunction with the software version in a computer server device of a vehicle manufacturer, 2) stored and managed in the vehicle, and 3) read from the vehicle through a diagnostic device. Furthermore, 4) the RXSWIN should be updated in the vehicle when software that has legal impact (affecting type approval) is modified, 5) consistency should be verified to ensure that the RXSWIN value in the vehicle and the RXSWIN value of the vehicle manufacturer's server are the same, and 6) the RXSWIN history should be recorded and saved for each Vehicle Identification Number (VIN).

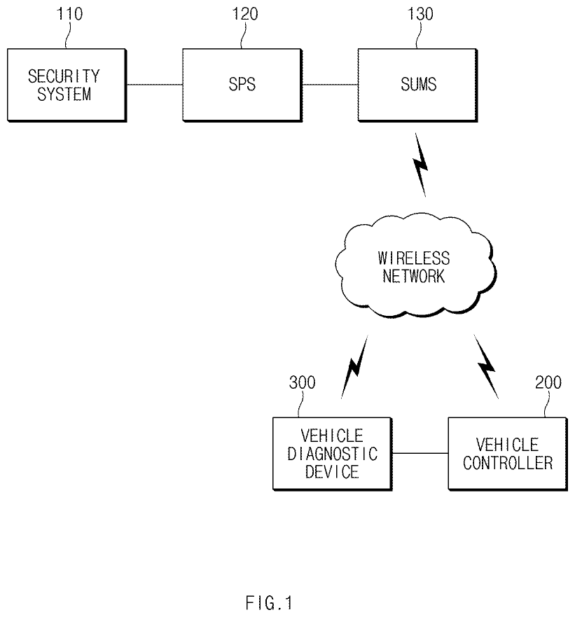

FIG. 1 is a schematic diagram of a software integrity verification system of a vehicle controller, according to an exemplary embodiment of the present disclosure.

As illustrated in FIG. 1, a software integrity verification system of the vehicle controller according to an exemplary embodiment of the present disclosure includes a security system 110, a Software Package Studio (SPS) 120, a Software Update Management System (SUMS) 130, a vehicle controller 200, and a vehicle diagnostic device 300. In the instant case, according to a manner of implementing the software integrity verification system of the vehicle controller according to an exemplary embodiment of the present disclosure, each component may be combined with each other to be implemented as one, or some components may be omitted.

Looking at each of the above components, first, the security system 110 generates firmware for each program forming the software loaded in the vehicle controller 200, and generates an Integrity Validation Data (IVD) based on the firmware for each program. In the instant case, the IVD may be a hash value based on the firmware. Furthermore, the IVD may be a hash value based on the entire region of ‘PURE ROM’ input to the security system 110.

The SPS 120 is a system for configured for generating a software package, and may be configured to generate a software package including firmware, a config file, and a hash value. In the instant case, the firmware is firmware generated by the security system 110, and the hash value is a hash value generated based on the config file.

The SUMS 130 may manage software packages, and version information and the IVD of the software packages for each program forming the software loaded in the vehicle controller 200.

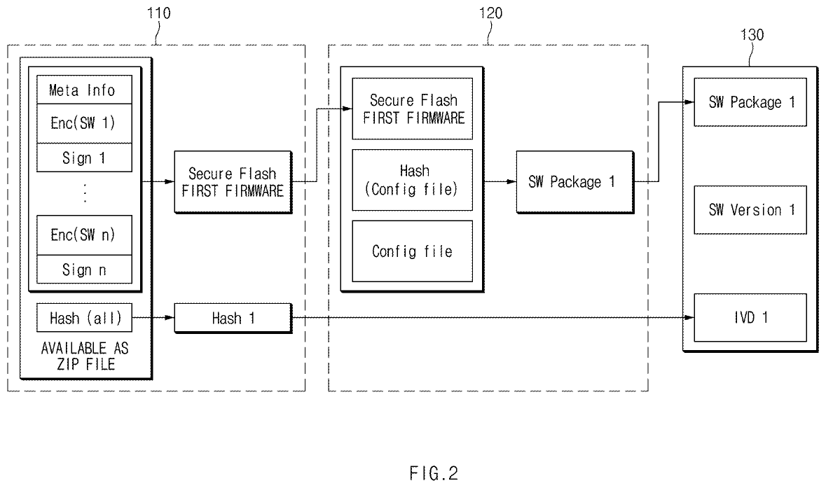

Hereinafter, with reference to FIG. 2, functions of the security system 110, the SPS 120, and the SUMS 130 will be described in detail.

FIG. 2 is a diagram illustrating functions of a security system, an SPS, and a SUMS provided in a software integrity verification system of a vehicle controller, according to an exemplary embodiment of the present disclosure.

As illustrated in FIG. 2, the security system 110 may be configured to generate a first firmware corresponding to a first program forming software loaded in the vehicle controller 200. Furthermore, the security system 110 may be configured to generate a first hash value (Hash 1) corresponding to the first firmware. In the instant case, the first hash value may be registered in the SUMS 130 as IVD 1.

The SPS 120 may be configured to generate a first software package (SW Package 1) including a first firmware, a config file, and a hash value corresponding to the config file.

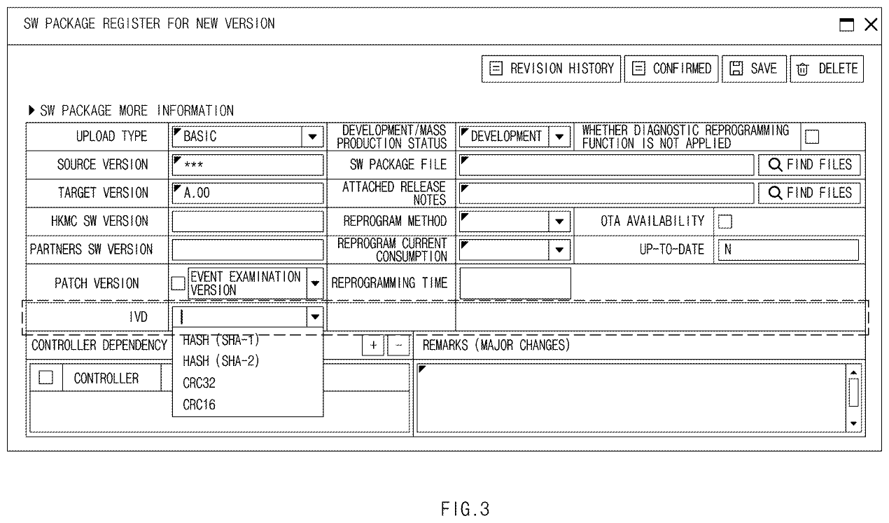

The SUMS 130 may register and manage a first software package corresponding to the first program, version information of the first software package, and IVD 1 of the first software package. In the instant case, a screen for registering detailed information on a software package is as illustrated in FIG. 3.

On the other hand, the vehicle controller 200 is a controller provided in a vehicle to perform various controls, and may include an Electronic Control Unit (ECU), an Integrated Body Unit (IBU), a Motor Control Unit (MCU), a Transmission Control Unit (TCU), and an Engine Control Unit (ECU), etc.

The vehicle controller 200 may perform a firmware update in conjunction with the SUMS 130. That is, the vehicle controller 200 may obtain a software package from the SUMS 130 and may perform a software update using firmware included in the software package. In the instant case, when a plurality of software packages are obtained, the vehicle controller 200 may store and manage IVDs corresponding to each software package (i.e., an IVD corresponding to each firmware or an IVD corresponding to each program). Accordingly, when the vehicle diagnostic device 300 requests an IVD, the IVD corresponding to each software package may be provided to the vehicle diagnostic device 300.

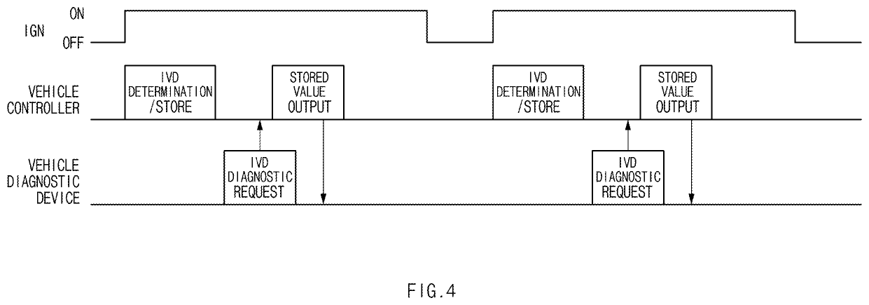

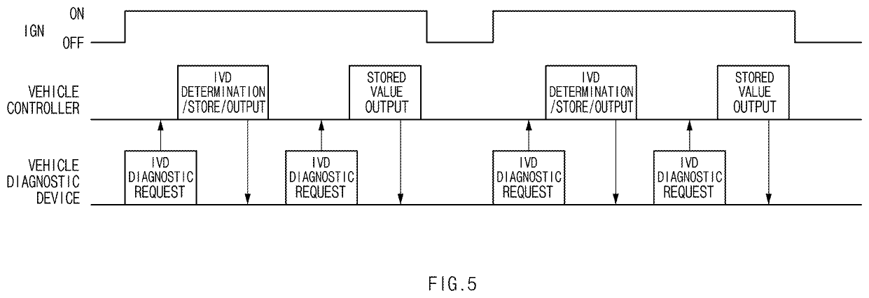

Furthermore, the vehicle controller 200 may be configured to determine the IVD based on a secure flash library or a crypto library. In the instant case, the vehicle controller 200 may be configured to determine any one of a Secure Hash Algorithm (SHA)-1 value (output value or calculated value), a SHA-2 value, a Cyclic Redundancy Check (CRC) 16 value (output value or calculated value), a CRC 32 value as the IVD. In the instant case, the timing at which the vehicle controller 200 is configured to determine the IVD is as illustrated in FIG. 4 and FIG. 5.

FIG. 4 is a first example diagram illustrating a time when a vehicle controller provided in a software integrity verification system of a vehicle controller according to an exemplary embodiment of the present disclosure is configured to determine an IVD.

As illustrated in FIG. 4, the vehicle controller 200 may be configured to determine an IVD every time the vehicle is turned on (IGN ON) and stores the IVD, and may output the stored IVD to the vehicle diagnosis device 300 upon request for IVD diagnosis from the vehicle diagnostic device 300. In the instant case, when the vehicle controller 200 receives an IVD diagnosis request from the vehicle diagnostic device 300 while determining the IVD, the vehicle controller 200 may output the IVD to the vehicle diagnostic device 300 after the IVD determination is completed.

FIG. 5 is a second example diagram illustrating a time when a vehicle controller provided in a software integrity verification system of a vehicle controller according to an exemplary embodiment of the present disclosure determines an IVD.

As illustrated in FIG. 5, the vehicle controller 200 may be configured to determine an IVD, may store the IVD, and may output the IVD to the vehicle diagnostic device 300 upon receiving a first IVD diagnosis request from the vehicle diagnostic device 300.

Accordingly, during the start-on cycle of the vehicle, when requesting the secondary IVD diagnosis from the vehicle diagnostic device 300, the vehicle controller 200 does not additionally determine the IVD but may output the previously determined IVD (the IVD determined upon request for the first IVD diagnosis) to the vehicle diagnosis device 300.

Since an ‘OBD-II Connector’ provided in the vehicle is connected to an in-vehicle gateway, the vehicle diagnostic device 300 may access various ECUs in the vehicle through the gateway, and thus may request diagnostic services from the various ECUs.

The vehicle diagnostic device 300 may include a software integrity verification apparatus 310 of the vehicle controller 200 according to an exemplary embodiment of the present disclosure, or the vehicle diagnostic device 300 may perform the function of the integrity verification apparatus 310. In the instant case, the integrity verification apparatus 310 may detect whether software is modified due to illegal hacking or illegal tuning in a aftermarket, in an environment in which the vehicle controller 200 performs a firmware update in conjunction with the SUMS 130, by obtaining a first IVD of the vehicle controller 200 from the SUMS 130, obtaining a second IVD from the vehicle controller 200, and verifying integrity of software loaded in the vehicle controller 200 based on the first IVD and the second IVD.

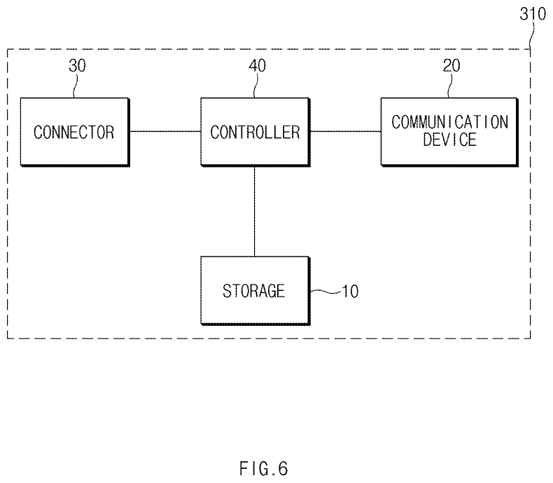

FIG. 6 is a schematic diagram of a software integrity verification system of a vehicle controller, according to an exemplary embodiment of the present disclosure.

As illustrated in FIG. 6, the software integrity verification apparatus 310 of a vehicle controller according to an exemplary embodiment of the present disclosure may include storage 10, a communication device 20, a connector 30, and a controller 40. In the instant case, according to a manner of implementing the software integrity verification apparatus 310 of the vehicle controller according to an exemplary embodiment of the present disclosure, each component may be combined with each other to be implemented as one, or some components may be omitted.

Looking at each of the above components, first, the storage 10 may store various logics, algorithms, and programs required in the process of verifying the integrity of the software loaded in the vehicle controller 200 based on a first IVD and a second IVD after obtaining the first IVD of the vehicle controller 200 from the SUMS 130 and obtaining the second IVD from the vehicle controller 200, in an environment in which the vehicle controller 200 performs a firmware update in conjunction with the SUMS 130.

The storage 10 may include at least one type of storage medium of a memory such as a flash memory type, a hard disk type, a micro type, and a card type (e.g., a Secure Digital card (SC card) or an EXtream Digital card (XD card)), and a memory such as a Random Access Memory (RAM), a Static RAM (SRAM), a Read-Only Memory (ROM), a Programmable ROM (PROM), an Electrically Erasable PROM (EEPROM), a Magnetic RAM (MRAM), a magnetic disk, and optical disk type memory.

The communication device 20 is a module that provides a communication interface with the SUMS 130, and may include at least one of a mobile communication module, a wireless Internet module, and a short-range communication module.

The mobile communication module may communicate with the SUMS 130 through a mobile communication network constructed based on technology standards or communication methods (e.g., a Global System for Mobile communication (GSM), a Code Division Multi Access (CDMA), a Code Division Multi Access 2000 (CDMA2000), an EV-DO (Enhanced Voice-Data Optimized or Enhanced Voice-Data Only), a Wideband CDMA (WCDMA), a High Speed Downlink Packet Access (HSDPA), a High Speed Uplink Packet Access (HSUPA), a Long Term Evolution (LTE), a Long Term Evolution-Advanced (LTE-A), or the like) for mobile communication.

The wireless Internet module is a module for wireless Internet access, and may communicate with the SUMS 130 through a Wireless LAN (WLAN), a Wireless-Fidelity (Wi-Fi), a Wireless Fidelity (Wi-Fi) Direct, a Digital Living Network Alliance (DLNA), a Wireless Broadband Internet (WiBro), a Worldwide Interoperability for Microwave Access (WiMAX), a High Speed Downlink Packet Access (HSDPA), a High Speed Uplink Packet Access (HSUPA), an Long Term Evolution (LTE), a Long Term Evolution-Advanced (LTE-A), or the like.

The short-range communication module may support short-range communication with the SUMS 130 using at least one of technologies of a Bluetooth™, an Radio Frequency Identification (RFID), an Infrared Data Association (IrDA), a Ultra Wideband (UWB), a ZigBee, an Near Field Communication (NFC), a Wireless Universal Serial Bus (USB).

The connector 30 is a module providing a connection interface with the vehicle controller 200, and may include an OBD-II connector.

The controller 40 may perform overall control so that each of the components may perform their functions normally. The controller 40 may be implemented in a form of hardware, or may be implemented in a form of software, or may be implemented in a form of a combination of hardware and software. The controller 40 may be implemented as a microprocessor, but is not limited thereto.

The controller 40 may perform various controls in a process of obtaining the first IVD of the vehicle controller 200 from the SUMS 130, obtaining the second IVD from the vehicle controller 200, and verifying the integrity of the software loaded in the vehicle controller 200 based on the first IVD and the second IVD.

When the first IVD and the second IVD are the same to each other, the controller 40 verifies the integrity of the software loaded in the vehicle controller 200. That is, the controller 40 is configured to determine that the software loaded in the vehicle controller 200 has the integrity.

When the first IVD and the second IVD are not the same to each other, the controller 40 does not verify the integrity of the software loaded in the vehicle controller 200. That is, the controller 40 is configured to determine that the software loaded in the vehicle controller 200 has no integrity.

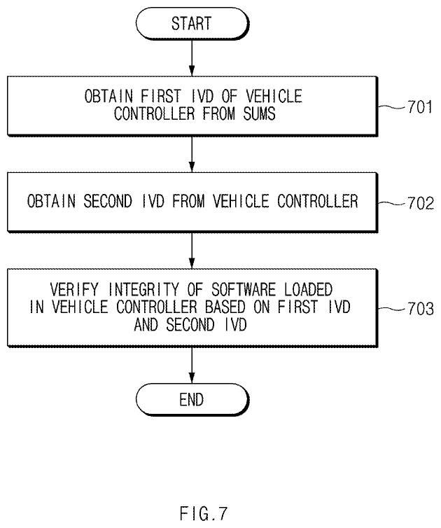

FIG. 7 is a flowchart of a software integrity verification method of a vehicle controller, according to an exemplary embodiment of the present disclosure.

First, the controller 40 obtains the first IVD of the vehicle controller 200 from the SUMS 130 (701).

Thereafter, the controller 40 obtains the second IVD from the vehicle controller 200 (702).

Thereafter, the controller 40 verifies the integrity of the software loaded in the vehicle controller 200 based on the first IVD and the second IVD (703). In the instant case, the controller 40 may be configured to determine that the software loaded in the vehicle controller 200 has integrity when the first IVD and the second IVD are the same to each other.

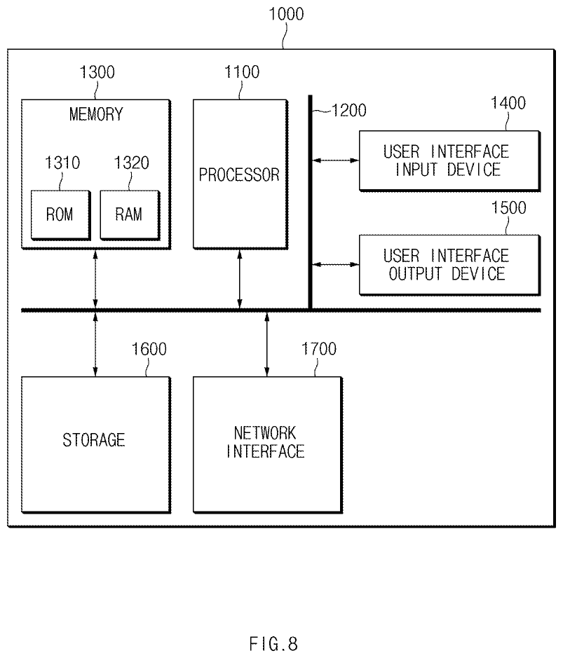

FIG. 8 is a block diagram illustrating a computing system for executing a software integrity verification method of a vehicle controller, according to an exemplary embodiment of the present disclosure.

Referring to FIG. 8, a software integrity verification method of a vehicle controller according to an exemplary embodiment of the present disclosure may be implemented through a computing system. A computing system 1000 may include at least one processor 1100, a memory 1300, a user interface input device 1400, a user interface output device 1500, storage 1600, and a network interface 1700, which are connected to each other through a system bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, the operations of the method or algorithm described in connection with the exemplary embodiments included in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM). The storage medium as an example may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an exemplary embodiment of the present disclosure, the apparatus and method for verifying the software integrity of a vehicle controller may detect whether software is modified due to illegal hacking or illegal tuning in a aftermarket, in an environment in which the vehicle controller is configured to perform a firmware update in conjunction with a software update management system (SUMS), by obtaining a first IVD (Integrity Validation Data) of the vehicle controller from the SUMS (Software Update Management System), obtaining a second IVD from the vehicle controller, and verifying integrity of software loaded in the vehicle controller based on the first IVD and the second IVD.

The above description is merely illustrative of the technical idea of the present disclosure, and those of ordinary skill in the art to which the present disclosure pertains will be able to make various modifications and variations without departing from the essential characteristics of the present disclosure.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus of verifying a software integrity of a vehicle controller, the apparatus comprising:
a communication device configured to provide a communication interface with a software management system; and
a controller configured to obtain first verification data of the vehicle controller from the software management system, to obtain second verification data from the vehicle controller, and to verify an integrity of software loaded in the vehicle controller based on the obtained first verification data and the obtained second verification data.

2. The apparatus of claim 1, wherein the controller is configured to determine that the software loaded in the vehicle controller has the integrity, when the controller concludes that the obtained first verification data and the obtained second verification data are identical to each other.

3. The apparatus of claim 1, wherein the controller is configured to obtain a plurality of verification data corresponding to the vehicle controller from the software management system, to compare whether the plurality of verification data obtained from the software management system and a plurality of verification data obtained from the vehicle controller are identical to each other when the plurality of verification data is obtained from the vehicle controller, and to determine that the software loaded in the vehicle controller has the integrity when the controller concludes that the verification data are identical to each other.

4. The apparatus of claim 1, wherein the software management system is configured to manage a software package and version information and verification data of the software package for respective program forming the software loaded in the vehicle controller.

5. The apparatus of claim 4, wherein the vehicle controller is configured to perform a firmware update based on the software package received from the software management system.

6. The apparatus of claim 5, wherein the vehicle controller is configured to determine verification data based on the software package when a vehicle is started on (IGN ON), and transmits the verification data upon request from the controller.

7. The apparatus of claim 5, wherein the vehicle controller is configured to determine verification data based on the software package upon request from the controller, and to transmit the determined verification data to the controller.

8. The apparatus of claim 7, wherein the vehicle controller is configured to transmit the determined verification data to the controller when an additional request is received from the controller, without determining additionally the verification data when a vehicle is started on (IGN ON).

9. The apparatus of claim 1, wherein the vehicle controller is configured to determine the second verification data based on a secure flash library or a crypto library.

10. The apparatus of claim 9, wherein the second verification data is one of a Secure Hash Algorithm (SHA)-1 value, a SHA-2 value, a Cyclic Redundancy Check (CRC) 16 value, or a CRC 32 value.

11. A method of verifying a software integrity of a vehicle controller, the method comprising:
obtaining, by a controller, first verification data of the vehicle controller from a software management system;
obtaining, by the controller, second verification data from the vehicle controller; and
verifying, by the controller, an integrity of software loaded in the vehicle controller based on the obtained first verification data and the obtained second verification data.

12. The method of claim 11, wherein the verifying of the integrity of the software loaded in the vehicle controller includes:
Determining, by the controller, that the software loaded in the vehicle controller has the integrity, when the controller concludes that the obtained first verification data and the obtained second verification data are identical to each other.

13. The method of claim 11, wherein the verifying of the integrity of the software loaded in the vehicle controller further includes:
obtaining, by the controller, a plurality of verification data corresponding to the vehicle controller from the software management system, and comparing, by the controller, whether the plurality of verification data obtained from the software management system and a plurality of verification data obtained from the vehicle controller are identical to each other when the plurality of verification data is obtained from the vehicle controller; and
determining, by the controller, that the software loaded in the vehicle controller has the integrity when the controller concludes that the verification data are identical to each other.

14. The method of claim 11, further including:
managing, by the software management system, a software package and version information and verification data of the software package for respective program forming the software loaded in the vehicle controller; and
performing, by the vehicle controller, a firmware update based on the software package received from the software management system.

15. The method of claim 14, further including:
determining, by the vehicle controller, verification data based on the software package when a vehicle is started on (IGN ON); and
transmitting, by the vehicle controller, the verification data upon request from the controller.

16. The method of claim 14, further including:
determining, by the vehicle controller, verification data based on the software package upon request from the controller; and
transmitting, by the vehicle controller, the determined verification data to the controller.

17. The method of claim 16, further including:
transmitting, by the vehicle controller, the determined verification data to the controller when an additional request is received from the controller, without determining additionally the verification data when a vehicle is started on (IGN ON).

18. The method of claim 11, wherein the obtaining of the second verification data from the vehicle controller includes determining, by the vehicle controller, the second verification data based on a secure flash library or a crypto library.

19. The method of claim 18, wherein the second verification data is one of a Secure Hash Algorithm (SHA)-1 value, a SHA-2 value, a Cyclic Redundancy Check (CRC) 16 value, or a CRC 32 value.
